(19) United States
(12) Patent Application Publication
(10) Pub. No.: US 2006/0119313 A1
(43) Pub. Date: Jun. 8, 2006

(54) Bluetooth GPS receiver with a solar panel

(76) Inventor: Keng-Hao Chang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/290,586

(22) Filed: Dec. 1, 2005

(30) Foreign Application Priority Data
Dec. 6, 2004 (TW) 093219606

(51) Int. Cl. H02J 7/00

(52) U.S. Cl. 320/101

(57) ABSTRACT

A Bluetooth GPS receiver with a solar panel includes an electric circuit board and a solar panel positioned on and electrically connected with the electric circuit board. Then the solar panel together with the electric circuit board is deposited between an upper shell and a lower shell of the receiver. The upper shell is further provided with a transparent board just on the solar panel to let sunlight shine on the solar panel through the transparent board, so the solar panel may absorb and convert solar energy into electricity to be used directly by the receiver and also to charge a rechargeable battery placed in the lower shell, Then the battery may supply the receiver with electricity when there is no sunlight, and for a long period of time.

### BACKGROUND OF THE INVETNION

1. Field of the Invention

This invention relates to a Bluetooth GPS receiver with a solar panel, particularly to one provided with a solar panel for converting solar energy into electricity and also for charging a rechargeable battery so as to always supply the Bluetooth GPS receiver with electricity.

2. Description of the Prior Art

A conventional Bluetooth GPS receiver, as shown in FIG. 3, includes an electric circuit board placed between an upper shell 5 and a lower shell 6, a recessed space 61 formed in a lower portion of the lower shell 6 for receiving a battery 7 therein, and an underside cap 62 closing up the recessed space 61 and combined with the upper shell 5.

However, this conventional Bluetooth GPS receiver cannot function after the electricity of the battery is used up, and the battery 7 has to be replaced with a new one or recharged again if it is rechargeable, very inconvenient to use.

### SUMMARY OF THE INVNETION

This invention has been devised to offer a Bluetooth GPS receiver with a solar panel, and formed integral in a shell of the Bluetooth GPS receiver itself.

The feature of the invention is a solar panel positioned on an electric circuit board located between an upper shell and a lower shell of the shell of a Bluetooth GPS receiver, and a transparent board is fixed as a partial upper shell just on the solar panel so that sunlight may penetrate through the transparent board to shine on the solar panel, which then absorbs and converts the sunlight energy into electricity, which may be directly used by or stored in a rechargeable battery for the Bluetooth GPS receiver use any time, specially during there is no sunlight.

### BRIEF DESCRIPTION OF DRAWINGS

This invention will be better understood by referring to the accompanying drawings, wherein:

FIG. 1 is an exploded perspective view of a Bluetooth GPS receiver with a solar panel in the present invention;

FIG. 2 is a perspective view of the Bluetooth GPS receiver with a solar panel in the present invention; and,

FIG. 3 is an exploded perspective view of a conventional Bluetooth GPS receiver.

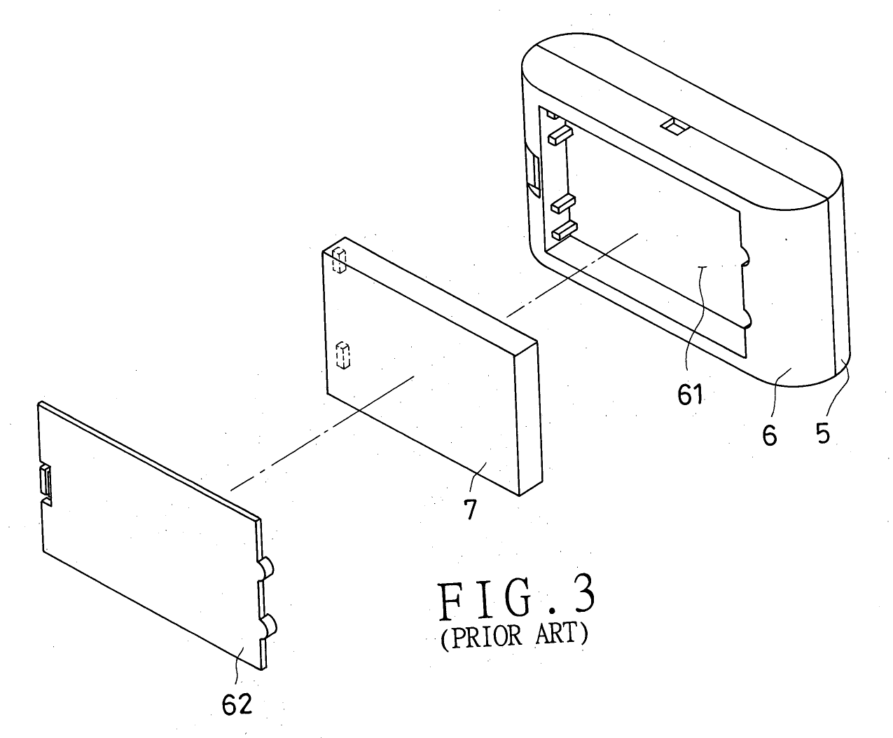

### DETAILED DESCRIPTION OF THE PREFERED EMBODIMENT

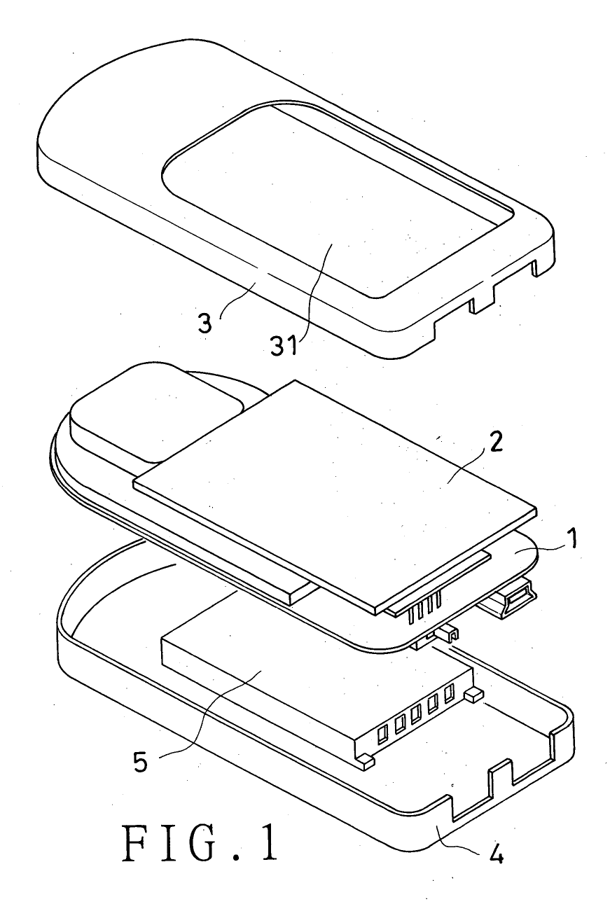

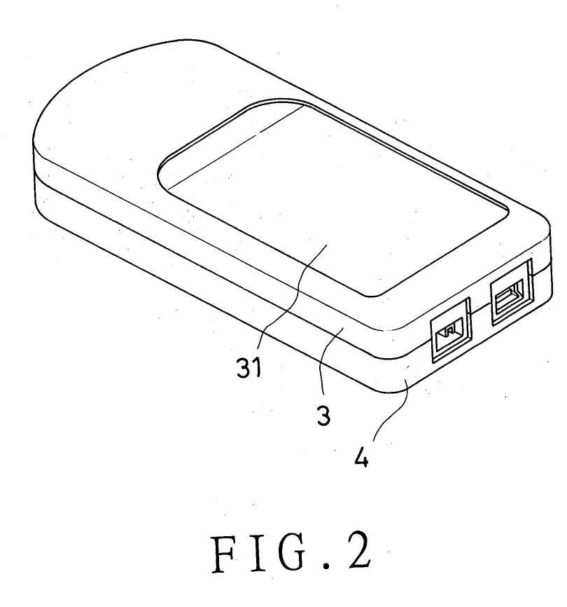

A preferred embodiment of a Bluetooth GPS receiver with a solar panel in the present invention, as shown in FIGS. 1 and 2, includes an electric circuit board 1, a solar panel 2, and s shell consisting of an upper shell 3 and a lower shell 4 and a rechargeable battery 5.

The electric circuit board 1 is deposited between the upper shell 3 and the lower shell 4, and the solar panel 2 is positioned on and electrically connected with the electric circuit board 1 in the shell. Further, the upper shell 3 is provided with a transparent board 31 as a portion of its body just on the solar panel 2 so that sunlight may shine on the solar panel 2 through the transparent board 31 to permit the solar panel absorb and converting sunlight into electricity to be directly used by the Bluetooth GPS receiver. Further, the rechargeable battery 5 is deposited in the lower shell 4 and electrically connected with the electric circuit board 1 for storing electricity generated by the solar panel 2 so as to be used by the Bluetooth GPS receiver when there is no sunlight.

In using, referring to FIG. 2, the upper shell 3 of the Bluetooth GPS receiver is placed to face upward, letting the solar panel receive sunlight through the transparent board 31 of the upper shell 3. Then sunlight energy may be converted into electricity to be directly used by the Bluetooth GPS receiver or to charge the rechargeable battery 5 for later use.

The invention has the follow advantages, as can be understood from the foresaid description.
1. The Bluetooth GPS receiver can function as long as there is sunlight, even if the electricity of the battery is used up, very convenient.
2. The rechargeable battery can be charged and stored with electricity by the function of the solar panel any time when the Bluetooth GPS receiver is not used, so the rechargeable battery can supply the Bluetooth GPS receiver with electricity any time, especially during no sunlight available.

While the preferred embodiment of the invention has been described above, it will be recognized and understood that various modifications may be made therein and the appended claims are intended to cover all such modifications that may fall within the spirit and scope of the invention.

What is claimed is:

1. A Bluetooth GPS receiver with a solar panel comprising an electric circuit board and a solar board positioned on and electrically connected with said electric circuit board, said solar panel together with said electric circuit board deposited between an upper shell and a lower shell of said Bluetooth GPS receiver, said upper shell provided with a transparent board just on said solar panel so that sunlight may shine on said solar panel through said transparent board, a rechargeable battery placed in said lower shell and electrically connected with said electric circuit board, said solar panel possible to absorb and convert sunlight energy into electricity to be used directly by said Bluetooth GPS receiver and to charge said rechargeable battery as well so that said battery may supply said Bluetooth GPS receiver with electricity when there is no sunlight.
